(19) United States
(12) Patent Application Publication
(10) Pub. No.: US 2026/0290696 A1
(43) Pub. Date: Sep. 24, 2026

(54) MULTILAYER ELECTRONIC DEVICE AND METHOD OF MANUFACTURING THE SAME

(71) Applicant: TDK Corporation, Tokyo (JP)

(72) Inventors: Toshio SAKURAI, Tokyo (JP); Masahide ISHIZUYA, Tokyo (JP); Makoto ISHIZAKI, Tokyo (JP); Asuka MURAKAMI, Tokyo (JP); Noriyuki INOUE, Tokyo (JP); Yuki OKAFUJI, Tokyo (JP)

(73) Assignee: TDK Corporation, Tokyo (JP)

(21) Appl. No.: 19/570,329

(22) Filed: Mar. 18, 2026

(30) Foreign Application Priority Data
Mar. 21, 2025 (JP) 2025-047261

(51) Int. Cl. H01G 4/224; H01G 4/008; H01G 4/30; H01G 13/00

(52) U.S. Cl. CPC H01G 4/224; H01G 4/30; H01G 13/003; H01G 4/0085

(57) ABSTRACT

A multilayer electronic device includes an element body including internal electrode layers and dielectric layers, which are alternately laminated along a third axis direction and are substantially parallel to a plane containing a first axis and a second axis. The element body includes side surfaces facing each other in the first axis direction and each being provided with an insulating layer. The internal electrode layers include an internal electrode overlapping portion, which includes an overlapping portion side edge at either end in the first axis direction, and an internal electrode lead-out portion, which includes a lead-out portion side edge at either end in the first axis direction. The overlapping portion side edge includes an overlapping portion side edge central part at a center in the second axis direction. At least one of the internal electrode layers has larger irregularities along the second axis direction at the lead-out portion side edge than at the overlapping portion side edge central part.

### TECHNICAL FIELD

The present invention relates to a multilayer electronic device.

Demand for downsizing electronic devices has been increasing along with a recent increase in the density of electronic circuits included in digital electronics (e.g., mobile phones). Constituent multilayer electronic devices of these circuits have rapidly been reduced in size and increased in capacity.

Patent Document 1 discloses a method of manufacturing a multilayer ceramic capacitor. The method includes a step of printing internal electrodes continuing in a longitudinal direction in strips on molded continuous dielectric sheets, a step of continuously laminating the dielectric sheets with the printed internal electrodes and continuous dielectric sheets without printed internal electrodes, a step of cutting the resultant continuous laminate into pieces and then forming insulating layers at portions where no external electrodes are to be provided among exposed portions of the internal electrodes, and a step of forming external electrodes at the exposed portions of the internal electrodes.

However, the multilayer ceramic capacitor disclosed in Patent Document 1 only simply protects the side exposed internal electrodes with the insulating layers. Thus, in a situation where the number of the internal electrodes is increased to reduce distances between the internal electrodes along the lamination direction in particular, a corner portion of an element body or a boundary between an internal electrode overlapping portion and an internal electrode lead-out portion may have unstable thermal shrinkage behavior. Consequently, a crack may be generated during a heat treatment or the like, reducing the yield rate.
Patent Document 1: JP Patent Application Laid Open No. S59-222917

### SUMMARY

The present invention has been achieved in view of the above circumstances and aims to prevent a crack at a corner portion of an element body or in the vicinity of a boundary between an internal electrode lead-out portion and an internal electrode overlapping portion.

To achieve the above object, a multilayer electronic device according to the present disclosure is as follows.

The multilayer electronic device includes
an element body including internal electrode layers and dielectric layers, the internal electrode layers and the dielectric layers being alternately laminated along a direction of a third axis and being substantially parallel to a plane containing a first axis and a second axis,
wherein
the element body includes side surfaces in pairs each being provided with an insulating layer, the side surfaces facing each other in a direction of the first axis;
the element body includes end surfaces in pairs each being provided with an external electrode electrically connected to the internal electrode layers, the end surfaces facing each other in a direction of the second axis;
the internal electrode layers include first internal electrode layers and second internal electrode layers;
the first internal electrode layers connect to the external electrode on one of the end surfaces in pairs;
the second internal electrode layers connect to the external electrode on an other one of the end surfaces in pairs;
the internal electrode layers include an internal electrode overlapping portion and an internal electrode lead-out portion;
the internal electrode overlapping portion is where the first internal electrode layers and the second internal electrode layers overlap when viewed from the direction of the third axis;
the internal electrode lead-out portion is where the first internal electrode layers and the second internal electrode layers do not overlap when viewed from the direction of the third axis;
the internal electrode lead-out portion includes a lead-out portion side edge at either end in the direction of the first axis;
the internal electrode overlapping portion includes an overlapping portion side edge at either end in the direction of the first axis;
the overlapping portion side edge includes an overlapping portion side edge central part at a center in the direction of the second axis; and
at least one of the internal electrode layers has larger irregularities along the direction of the second axis at the lead-out portion side edge than at the overlapping portion side edge central part.

According to such a multilayer electronic device, the lead-out portion side edge of the internal electrode layer has the irregularities, where the internal electrode layer is partly dug toward a center in the first axis direction. According to such a multilayer electronic device, while adhesion between the lead-out portion side edge and its surrounding portion is controlled, the proportion of the internal electrode layer with thermal shrinkage behavior different from that of the dielectric layers or the insulating layer at a corner of the element body or in the vicinity of a boundary between the internal electrode lead-out portion and the internal electrode overlapping portion can be reduced. This can prevent stress concentration at vulnerable portions due to a difference in thermal shrinkage behavior between the internal electrode layer and the dielectric layers and the insulating layer and can appropriately control adhesion between layers near the lead-out portion side edge. Thus, the element body can be suitably prevented from having a crack.

Examples of specific forms of the above include the following.

It may be that, for example, in the at least one of the internal electrode layers,
a length along the direction of the first axis between the insulating layer and the lead-out portion side edge or the overlapping portion side edge is defined as a depth of the lead-out portion side edge or the overlapping portion side edge;
the lead-out portion side edge has lead-out portion side edge depressions each having a largest depth between two second-axially adjacent points at an average depth of the lead-out portion side edge;
the lead-out portion side edge depressions have an average depth of 0.2 to 10 μm;
the overlapping portion side edge central part has central part side edge depressions each having a largest depth between two second-axially adjacent points at an average depth of the overlapping portion side edge central part;
the central part side edge depressions have an average depth of 0 to 2 μm; and
the average depth of the lead-out portion side edge depressions is larger than the average depth of the central part side edge depressions.

It may be that, for example,
a length along the direction of the first axis between the insulating layer and the lead-out portion side edge or the overlapping portion side edge is defined as a depth of the lead-out portion side edge or the overlapping portion side edge;
the lead-out portion side edge has lead-out portion side edge depressions each having a largest depth between two second-axially adjacent points at an average depth of the lead-out portion side edge; and
the at least one of the internal electrode layers has a (A−B1−B2)/A of 0.9 or more, where
“A” denotes a maximum width of the internal electrode lead-out portion along the direction of the first axis,
“B1” denotes an average depth of the lead-out portion side edge depressions of the lead-out portion side edge at one side in the direction of the first axis, and
“B2” denotes an average depth of the lead-out portion side edge depressions of the lead-out portion side edge at an other side in the direction of the first axis.

It may be that, for example, both B1 and B2 are 0.2 to 10 μm.

It may be that, for example,
a length along the direction of the first axis between the insulating layer and the lead-out portion side edge or the overlapping portion side edge is defined as a depth of the lead-out portion side edge or the overlapping portion side edge;
in the at least one of the internal electrode layers,
the overlapping portion side edge central part has a maximum depth not exceeding 50% of that of the lead-out portion side edge;
the overlapping portion side edge includes an overlapping portion side edge uneven part having a maximum depth exceeding 50% of that of the lead-out portion side edge;
the overlapping portion side edge includes the overlapping portion side edge central part and the overlapping portion side edge uneven part; and
the overlapping portion side edge uneven part includes overlapping portion side edge uneven parts in pairs disposed at both sides of the overlapping portion side edge central part in the direction of the second axis.

It may be that, for example,
a length of the overlapping portion side edge central part along the direction of the second axis is 40% to 90% of an entire length of the at least one of the internal electrode layers along the direction of the second axis; and
a sum of lengths of the overlapping portion side edge uneven part and the lead-out portion side edge along the direction of the second axis is 10% to 60% of the entire length of the at least one of the internal electrode layers along the direction of the second axis.

It may be that, for example, a sum of lengths of the overlapping portion side edge uneven part and the lead-out portion side edge of the at least one of the internal electrode layers along the direction of the second axis is 40 to 100 μm.

It may be that, for example,
the lead-out portion side edge has a surface roughness Ra of 100 to 1000 nm along the direction of the second axis; and
the overlapping portion side edge central part has a surface roughness Ra being smaller than that of the lead-out portion side edge and being 10 to 200 nm along the direction of the second axis.

It may be that, for example, the multilayer electronic device includes a filler at least partly filling the irregularities of the lead-out portion side edge between the side surfaces of the element body and the insulating layer.

According to such a multilayer electronic device, an anchoring effect brought by filling the irregularities with the filler improves adhesion between the insulating layer and the element body. With the irregularities being filled with the filler, improvement in adhesion by the anchoring effect and reduction in the proportion of the electrode layer work synergistically. This can prevent stress concentration at the corner of the element body or in the vicinity of the boundary between the internal electrode lead-out portion and the internal electrode overlapping portion and an accompanying crack.

It may be that, for example, 90% or more of a composition of the filler in mole percent matches a composition of the insulating layer or the dielectric layers.

It may be that, for example, 20% or more of a composition of the filler in mole percent differs from a composition of the insulating layer or the dielectric layers.

It may be that, for example, the filler contains at least one selected from the group consisting of Mg, Si, and Mn; and a content of the at least one selected from the group consisting of Mg, Si, and Mn is higher by 0.01 to 3 mol % than that of the dielectric layers.

It may be that, for example,
the filler contains at least one selected from the group consisting of Mg, Si, and Mn; and the filler contains an oxide of a metal identical to a metal contained in the internal electrode layers.

### BRIEF DESCRIPTION OF THE DRAWING(S)

FIG. 1 is a schematic sectional view of a multilayer ceramic capacitor, which is a multilayer electronic device, according to one embodiment of the present disclosure.

FIG. 2 is a schematic perspective view of an element body and insulating layers of the multilayer ceramic capacitor illustrated in FIG. 1.

FIG. 3 is a schematic sectional view along a line III-III in FIG. 2.

FIG. 4A-4B is a pair of partial enlarged views of FIG. 3.

FIG. 5 is a schematic view of a first stage of manufacture of the ceramic capacitor illustrated in FIG. 1.

FIG. 6 is a schematic view of a second stage of manufacture of the ceramic capacitor illustrated in FIG. 1.

FIG. 7A-7B includes a sectional view of a second green chip illustrated in FIG. 6 and its partial enlarged view.

FIG. 8 is a schematic view of a third stage of manufacture of the ceramic capacitor illustrated in FIG. 1.

FIG. 9A-9B includes a sectional view of a third green chip illustrated in FIG. 8 and its partial enlarged view.

### DETAILED DESCRIPTION

Detailed description is provided based on the present embodiment with reference to the drawings; however, the present disclosure is not construed as limited only to the following embodiment.

Constituents described below include those that a person skilled in the art can easily conceive of or those that are substantially the same. Furthermore, the constituents described below can be recombined appropriately.

Hereinafter, the present disclosure is described based on the embodiment illustrated in the drawings.

As one embodiment of a multilayer electronic device according to the present embodiment, an overall configuration of a multilayer ceramic capacitor 10 is described.

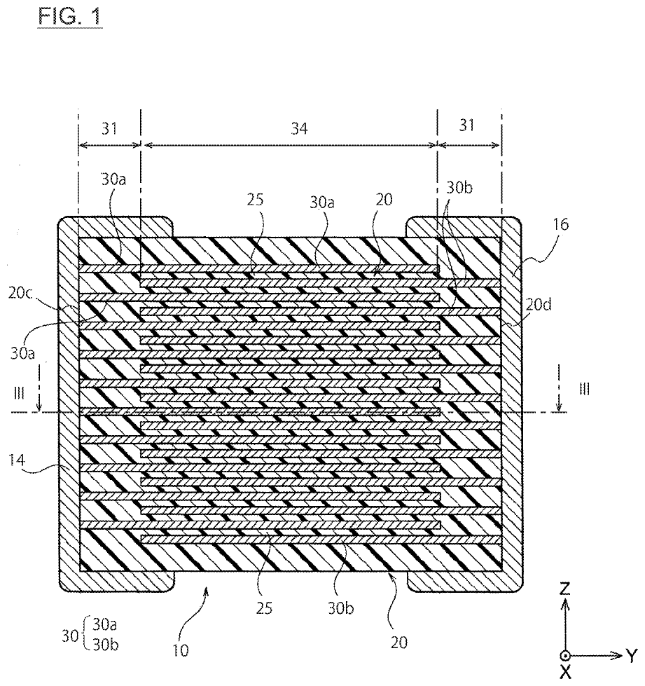

FIG. 1 is a schematic sectional view of the multilayer ceramic capacitor 10 according to the present embodiment. As illustrated in FIG. 1, the multilayer ceramic capacitor 10 includes an element body 20, where internal electrode layers 30 and dielectric layers 25, which are substantially parallel to a plane containing the X-axis as a first axis and the Y-axis as a second axis, are alternately laminated along the Z-axis as a third axis.

In this context, “substantially parallel” means that the internal electrode layers 30 and the dielectric layers 25 are mostly parallel to the plane but may partly be slightly nonparallel. This intends to convey that the internal electrode layers 30 and the dielectric layers 25 may be slightly uneven or inclined.

As illustrated in FIG. 1, end surfaces 20c and 20d of the element body 20 in pairs, which face each other in the second axis (Y-axis) direction, are provided with external electrodes 14 and 16, which electrically connect to the internal electrode layers 30, respectively. That is, the internal electrode layers 30 include first internal electrode layers 30a, which connect to the external electrode 14 on the end surface 20c, and second internal electrode layers 30b, which connect to the external electrode 16 on the end surface 20d. The first internal electrode layers 30a and the second internal electrode layers 30b are alternately laminated along the third axis (Z-axis), with the dielectric layers 25 in between.

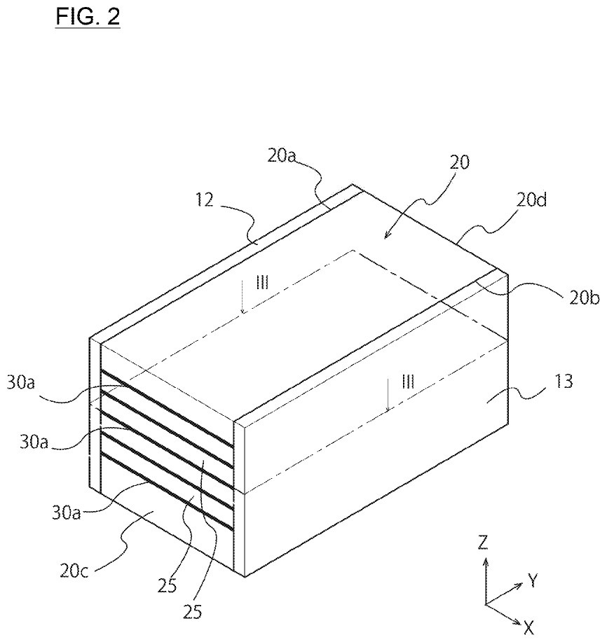

FIG. 2 is a schematic perspective view of the element body 20 and insulating layers 12 and 13 of the multilayer ceramic capacitor 10 illustrated in FIG. 1. FIG. 2 does not illustrate the external electrodes 14 and 16 (see FIG. 1) of the multilayer ceramic capacitor 10 in order to illustrate the end surface 20c of the element body 20. Note that, in FIGS. 1 and 2, the internal electrode layers 30 are illustrated to have a larger thickness (dimension in the Z-axis direction) than the actual dimension, and the internal electrode layers 30 and the dielectric layers 25 are simply and schematically illustrated to be fewer in number. The numbers of the internal electrode layers 30 and the dielectric layers 25 and the thickness of the internal electrode layers 30 are not limited.

As illustrated in FIG. 2, side surfaces 20a and 20b of the element body 20 in pairs, which face each other in the first axis (X-axis) direction, are provided with the insulating layers 12 and 13, respectively. The side surface 20a in the negative direction of the X-axis is provided with the insulating layer 12. The side surface 20b in the positive direction of the X-axis is provided with the insulating layer 13.

As illustrated in FIG. 1, the internal electrode layers 30 include an internal electrode overlapping portion 34 and internal electrode lead-out portions 31. The internal electrode overlapping portion 34 is where the first internal electrode layers 30a, which connect to the external electrode 14 on the end surface 20c of the pair of end surfaces 20c and 20d, and the second internal electrode layers 30b, which connect to the external electrode 16 on the end surface 20d of the pair, overlap when viewed from the Z-axis direction (third axis direction). The internal electrode lead-out portions 31 are where the first internal electrode layers 30a and the second internal electrode layers 30b do not overlap when viewed from the Z-axis direction (third axis direction).

As illustrated in FIG. 1, in the element body 20, the internal electrode overlapping portion 34 is disposed so as to be interposed between the internal electrode lead-out portions 31 in pairs from both sides in the Y-axis (second axis) direction. In other words, from the end surface 20c to the end surface 20d of the element body 20 along the second axis (Y-axis) direction, the internal electrode lead-out portion 31, the internal electrode overlapping portion 34, and the internal electrode lead-out portion 31 are disposed in sequence. The internal electrode lead-out portion 31 close to the end surface 20c is part of the first internal electrode layers 30a. The internal electrode lead-out portion 31 close to the end surface 20d is part of the second internal electrode layers 30b. The internal electrode overlapping portion 34 includes other part of the first internal electrode layers 30a and other part of the second internal electrode layers 30b.

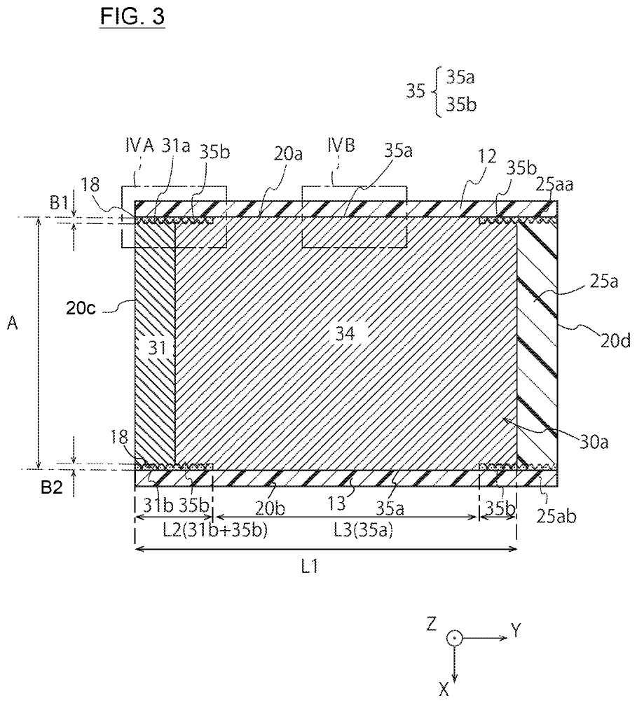

FIG. 3 is a sectional view along a line III-III in FIG. 2. That is, FIG. 3 is a schematic view of the element body 20 and the insulating layers 12 and 13 in a section that passes a center of one first internal electrode layer 30a, which is one of the internal electrode layers 30 included in the element body 20, in the third axis (Z-axis) direction and is parallel to the first axis and the second axis (X-axis and Y-axis).

As illustrated in FIG. 3, the first internal electrode layer 30a, which is one of the internal electrode layers 30 included in the element body, is interposed between the insulating layers 12 and 13 from both sides in the first axis (X-axis) direction. The first internal electrode layer 30a includes the internal electrode lead-out portion 31 close to the end surface 20c of the element body 20 and the internal electrode overlapping portion 34 more to a central side in the Y-axis direction relative to the internal electrode lead-out portion 31.

An end of the internal electrode lead-out portion 31 in the negative direction of the Y-axis is exposed to the end surface 20c of the element body 20. An end of the internal electrode lead-out portion 31 in the positive direction of the Y-axis connects to the internal electrode overlapping portion 34. An end of the internal electrode overlapping portion 34 in the negative direction of the Y-axis connects to the internal electrode lead-out portion 31. An end of the internal electrode overlapping portion 34 in the positive direction of the Y-axis connects to the dielectric layer 25. Thus, the end of the internal electrode overlapping portion 34 in the positive direction of the Y-axis is not exposed to the end surface 20d of the element body 20.

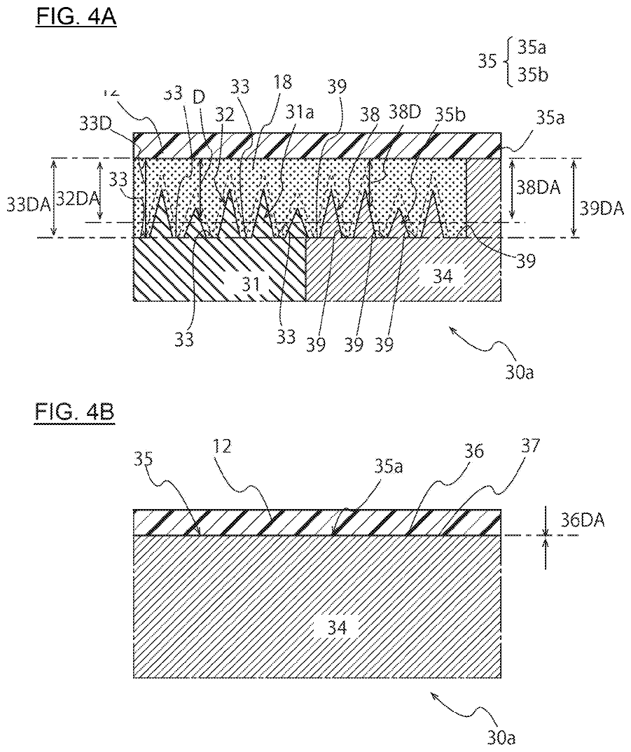

Side edges of the first internal electrode layer 30a, which constitute its both ends in the first axis (X-axis) direction, include lead-out portion side edges 31a and 31b of the internal electrode lead-out portion 31 and overlapping portion side edges 35 of the internal electrode overlapping portion 34. Each of the overlapping portion side edges 35 includes an overlapping portion side edge central part 35a and overlapping portion side edge uneven parts 35b. Details of the lead-out portion side edges 31a and 31b, the overlapping portion side edge central part 35a, and the overlapping portion side edge uneven parts 35b are provided later with reference to FIG. 4 and the like.

The lead-out portion side edges 31a and 31b (see FIG. 4(A)), which constitute both ends of the internal electrode lead-out portion 31 in the first axis (X-axis) direction, have larger irregularities along the second axis direction than the overlapping portion side edge central part 35a (see FIG. 4(B)), which is a central part, in the second axis (Y-axis) direction, of each of the overlapping portion side edges 35 constituting both ends of the internal electrode overlapping portion in the first axis (X-axis) direction.

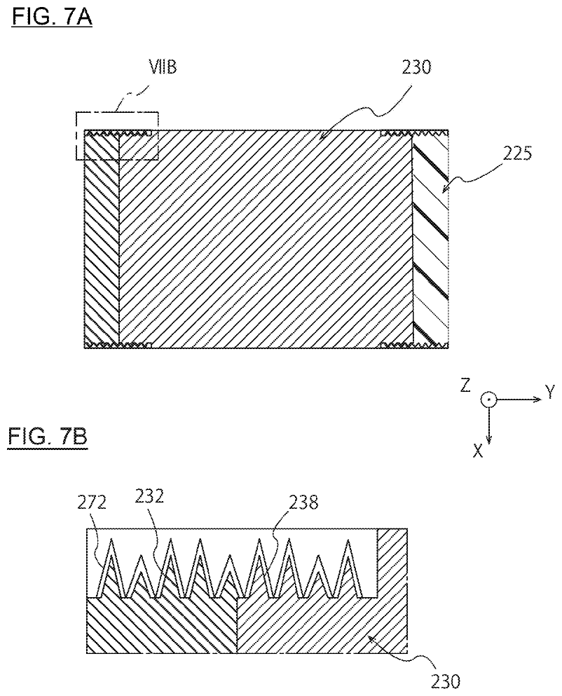

FIG. 4(A) is a partial enlarged view of the lead-out portion side edge 31a in FIG. 3 and its surroundings. FIG. 4(B) is a partial enlarged view of the overlapping-portion side edge central part 35a in FIG. 3 and its surroundings. As illustrated in FIG. 4(A), the lead-out portion side edge 31a has irregularities 32 having a depth D that repeatedly changes along the Y-axis direction, where the depth D denotes the length along the first axis (X-axis) direction, at any point of the lead-out portion side edge 31a, between the insulating layer 12 and the lead-out portion side edge 31a. Note that, although the irregularities 32 of the lead-out portion side edge 31a illustrated in this embodiment are filled with a filler 18, a space defined by the irregularities 32 between the lead-out portion side edge 31a and the insulating layer 12 may be a pore (see FIG. 7(B)).

The lead-out portion side edge 31a has lead-out portion side edge depressions 33, at which the depth D is locally maximized. As illustrated in FIG. 4(A), the lead-out portion side edge depressions 33 are where the depth D is the largest between two second-axially (Y-axially) adjacent points of the lead-out portion side edge 31a at the depth D being an average depth 32DA of the lead-out portion side edge 31a.

In the example illustrated in FIG. 4(A), the lead-out portion side edge 31a has five lead-out portion side edge depressions 33; however, the number of the lead-out portion side edge depressions 33 of the lead-out portion side edge 31a or the number of times the irregularities 32 repeat is not limited. In terms of effectively preventing a crack though, preferred is that the lead-out portion side edge 31a has four or more lead-out portion side edge depressions 33.

The lead-out portion side edge depressions 33 may have any depth 33D. However, the lead-out portion side edge depressions 33 of the lead-out portion side edge 31a can have an average depth 33DA of 0.2 to 10 μm. The depth 33D of the lead-out portion side edge depressions 33 being not smaller than the predetermined value makes it easier to avoid stress concentration. The depth 33D of the lead-out portion side edge depressions 33 being not larger than the predetermined value prevents reduction in the strength of the lead-out portion side edge 31a itself. Note that, for similar reasons, subtracting the average depth 32DA of the lead-out portion side edge 31a from the average depth 33DA of the lead-out portion side edge depressions 33 can give a value of 0.1 to 5 μm.

The lead-out portion side edge 31a can have a surface roughness Ra of, for example, 100 to 1000 nm along the second axis (Y-axis) direction. The surface roughness Ra of the lead-out portion side edge 31a being not smaller than the predetermined value makes it easier to avoid stress concentration. The surface roughness Ra of the lead-out portion side edge 31a being not larger than the predetermined value prevents reduction in the strength of the lead-out portion side edge 31a itself.

As illustrated in FIG. 4(B), the overlapping portion side edge central part 35a has irregularities 36 smaller than the irregularities 32 of the lead-out portion side edge 31a illustrated in FIG. 4(A). However, the overlapping portion side edge central part 35a may have no irregularities. FIGS. 4(A) and 4(B) schematically illustrate the lead-out portion side edge 31a and the overlapping portion side edge central part 35a enlarged at the same magnification. The irregularities 36 of the overlapping portion side edge central part 35a are small to the extent that they cannot be illustrated.

That is, similarly to the lead-out portion side edge 31a, the overlapping portion side edge central part 35a illustrated in FIG. 4(B) also has the irregularities 36 having a depth D that repeatedly changes along the Y-axis direction, where the depth D (see FIG. 4(A)) denotes the length along the first axis (X-axis) direction, at any point of the overlapping portion side edge 35, between the insulating layer 12 and the overlapping portion side edge 35. However, as described above, the irregularities 36 of the overlapping portion side edge central part 35a are small to the extent that they are unidentifiable in FIG. 4(B).

Similarly to the lead-out portion side edge 31a, the overlapping portion side edge central part 35a can as well have its central part side edge depressions 37 defined. The central part side edge depressions 37 are where the depth D is locally maximized. As illustrated in FIG. 4(B), the central part side edge depressions 37 are where the depth D is the largest between two second-axially (Y-axially) adjacent points of the overlapping portion side edge central part 35a at the depth D being an average depth 36DA of the overlapping portion side edge central part 35a.

The central part side edge depressions 37 may have any depth. The central part side edge depressions 37 of the overlapping portion side edge central part 35a can have an average depth of 0 to 2 μm. However, preferred is that the average depth of the central part side edge depressions 37 is smaller than the average depth 33DA of the depth 33D of the lead-out portion side edge depressions 33 of the lead-out portion side edge 31a located on the same side surface 20a side of the same first internal electrode layer 30a (i.e., preferred is that the average depth 33DA of the depth 33D of the lead-out portion side edge depressions 33 is larger than the average depth of the corresponding central part side edge depressions 37).

In terms of, for example, providing suitable adhesion between the insulating layer 12 and the side surface 20a, preferred is that the overlapping portion side edge central part 35a has a surface roughness Ra that is, for example, smaller than the surface roughness Ra of the corresponding lead-out portion side edge 31a and 10 to 200 nm along the second axis (Y-axis) direction. For similar reasons, preferred is that the overlapping portion side edge central part 35a has a maximum depth not exceeding 50% of that of the corresponding lead-out portion side edge 31a.

As illustrated in FIGS. 3 and 4(A), at the side edge, which constitutes either end of the first internal electrode layer 30a in the X-axis direction, the irregularities 32 of the lead-out portion side edge 31a extendedly continue along the Y-axis direction to part of the overlapping portion side edge 35, which connects to the lead-out portion side edge 31a. That is, as illustrated in FIG. 4(A), the overlapping portion side edge 35 includes the overlapping portion side edge uneven part 35b illustrated in FIG. 4(A), in addition to the overlapping portion side edge central part 35a illustrated in FIG. 4(B).

As illustrated in FIG. 4(A), the overlapping portion side edge uneven part 35b is at an end, connected to the lead-out portion side edge 31a, of the overlapping portion side edge 35 in the negative direction of the Y-axis. As illustrated in FIG. 3, another overlapping portion side edge uneven part 35b is at an end, connected to the dielectric layer 25, of the overlapping portion side edge 35 in the positive direction of the Y-axis. As illustrated in FIG. 3, the side edge of the first internal electrode layer 30a in the positive direction of the X-axis includes the overlapping portion side edge central part 35a and the overlapping portion side edge uneven parts 35b in pairs disposed at both sides of the overlapping portion side edge central part 35a in the second axis (Y-axis) direction. The same applies to the side edge of the first internal electrode layer 30a in the negative direction of the X-axis.

As illustrated in FIG. 4(A), the overlapping portion side edge uneven part 35b has irregularities 38 larger than those of the overlapping portion side edge central part 35a illustrated in FIG. 4(B). The overlapping portion side edge uneven part 35b has, for example, the irregularities 38 similar to the irregularities 32 of the lead-out portion side edge 31a. However, the irregularities 38 of the overlapping portion side edge uneven part 35b may differ from the irregularities 32 of the lead-out portion side edge 31a. The overlapping portion side edge uneven part 35b has a maximum depth preferably exceeding 50% of that of the corresponding lead-out portion side edge 31a.

Similarly to the irregularities 32 of the lead-out portion side edge 31a, the irregularities 38 of the overlapping portion side edge uneven part 35b illustrated in FIG. 4(A) are defined as having a depth D that repeatedly changes along the Y-axis direction, where the depth D denotes the length along the first axis (X-axis) direction, at any point of the overlapping portion side edge 35, between the insulating layer 12 and the overlapping portion side edge 35.

Similarly to the lead-out portion side edge 31a, the overlapping portion side edge uneven part 35b can as well have its uneven part side edge depressions 39 defined. The uneven part side edge depressions 39 are where the depth D is locally maximized. As illustrated in FIG. 4(A), the uneven part side edge depressions 39 are where the depth D is the largest between two second-axially (Y-axially) adjacent points of the overlapping portion side edge uneven part 35b at the depth D being an average depth 38DA of the overlapping portion side edge uneven part 35b.

The uneven part side edge depressions 39 may have any depth 39D. The uneven part side edge depressions 39 of the overlapping portion side edge uneven part 35b can have an average depth 39DA of 0.2 to 10 μm, similarly to the lead-out portion side edge depressions 33. The depth 39D of the uneven part side edge depressions 39 being not smaller than the predetermined value makes it easier to avoid stress concentration. The depth 39D of the uneven part side edge depressions 39 being not larger than the predetermined value can prevent reduction in the strength of the overlapping portion side edge uneven part 35b itself. Note that, for similar reasons, subtracting the average depth 38DA of the overlapping portion side edge uneven part 35b from the average depth 39DA of the uneven part side edge depressions 39 can give a value of 0.1 to 5 μm.

The same of the lead-out portion side edge 31a is applicable to surface roughness Ra of the overlapping portion side edge uneven part 35b along the second axis (Y-axis) direction or the filler 18 disposed in the irregularities 38.

As illustrated in FIGS. 1 and 3, a dielectric layer end 25a of the dielectric layer 25 may have irregularities that are similar to or slightly smaller than those of the lead-out portion side edge 31a. The dielectric layer end 25a overlaps other internal electrode layers (the second internal electrode layers 30b in FIG. 1) when viewed from the third axis (Z-axis) direction. The irregularities may be at dielectric layer end side edges 25aa and 25ab of the dielectric layer end 25a, which constitute both ends of the dielectric layer end 25a in the first axis (X-axis) direction. In this situation, the irregularities of the dielectric layer end side edges 25aa and 25ab illustrated in FIG. 3 can have shape characteristics similar to those of the irregularities 32 of the lead-out portion side edge 31a or the irregularities 38 of the overlapping portion side edge uneven part 35b.

As illustrated in FIG. 3, at the side edge of the first internal electrode layer 30a, a length L3 of the overlapping portion side edge central part 35a along the second axis (Y-axis) direction can be 40% to 90% of an entire length L1 of the first internal electrode layer 30a along the second axis (Y-axis) direction. Also, at the side edge of the first internal electrode layer 30a, a sum L2 of the lengths of the overlapping portion side edge uneven parts 35b and the lead-out portion side edge 31b along the second axis (Y-axis) direction can be 10% to 60% of the entire length L1 of the first internal electrode layer 30a along the second axis (Y-axis) direction.

The predetermined range of the proportion of the overlapping portion side edge uneven parts 35b and the lead-out portion side edge 31a, which have the large irregularities, relative to the side edge of the first internal electrode layer 30a as a whole can effectively mitigate stress and increase an anchoring effect with respect to the insulating layer 12 or the filler 18 for an increase in adhesion of each portion or part.

For similar reasons, preferred is that the sum L2 of the lengths of the overlapping portion side edge uneven parts 35b and the lead-out portion side edge 31b along the second axis (Y-axis) direction at the side edge of the first internal electrode layer 30a is 40 to 100 μm. However, the sum of the lengths of the overlapping portion side edge uneven parts 35b and the lead-out portion side edge 31b along the second axis (Y-axis) direction and their proportion relative to the side edge as a whole can be appropriately changed according to the size of the multilayer ceramic capacitor 10 or the thickness or the number of the internal electrode layers 30 or the dielectric layers 25.

As illustrated in FIG. 3, the lead-out portion side edge 31b, which is the end of the internal electrode lead-out portion 31 in the positive direction of the X-axis, has irregularities similar to those of the lead-out portion side edge 31a illustrated in FIG. 4(A). Also, the side edge of the internal electrode overlapping portion 34 in the positive direction of the X-axis and the side edge of the dielectric layer end 25a in the positive direction of the X-axis are similar to the corresponding side edges in the negative direction of the X-axis described above.

Preferred is that A, B1, and B2 satisfy the following formula 1, where A denotes a maximum width of the internal electrode lead-out portion 31 along the first axis (X-axis) direction illustrated in FIG. 3, B1 denotes an average depth of the lead-out portion side edge depressions 33 of the lead-out portion side edge 31a in the negative direction of the X-axis (one side of the first axis) (the average depth 33DA in FIG. 4(A)), and B2 denotes an average depth of the lead-out portion side edge depressions 33 of the lead-out portion side edge 31b in the positive direction of the X-axis (the other side of the first axis).

(A−B1−B2)/A≥0.9 Formula 1

The value of (A−B1−B2)/A being 0.9 or more can optimize the depth of the irregularities of the lead-out portion side edges 31a and 31b, preventing stress concentration at vulnerable portions due to a difference in thermal shrinkage behavior between the internal electrode layers 30 and the dielectric layers 25 and the insulating layers 12 and 13 and controlling adhesion between layers near the lead-out portion side edges 31a and 31b within an appropriate range.

For similar reasons, preferred is that both B1 (the average depth of the lead-out portion side edge depressions 33 of the lead-out portion side edge 31a) and B2 (the average depth of the lead-out portion side edge depressions 33 of the lead-out portion side edge 31b) are 0.2 to 10 μm.

As illustrated in FIGS. 3 and 4, the multilayer ceramic capacitor 10 includes the filler 18, which at least partly fills the irregularities of the lead-out portion side edges 31a and 31b between the side surfaces 20a and 20b of the element body 20 and the insulating layers 12 and 13. The filler 18 is not limited. Examples of main constituent materials of the filler 18 include the dielectric layers 25 of the element body 20 and a constituent insulating material of the insulating layers 12 and 13.

For example, 90% or more of the composition of the filler 18 in mole percent may match the composition of the insulating layers 12 and 13 or the dielectric layers 25. Such a filler 18 can prevent thermal shrinkage behavior of a material near the filler 18, preventing a crack near the lead-out portion side edges 31a and 31b.

Alternatively, for example, 20% or more of the composition of the filler 18 in mole percent may differ from the composition of the insulating layers 12 and 13 or the dielectric layers 25. Because there is a conductive material (e.g., the internal electrode layers 30) near the filler 18, a slight difference in the composition and the thermal shrinkage behavior from the insulating layers 12 and 13 or the dielectric layers 25 can mitigate stress concentration, preventing a crack near the lead-out portion side edges 31a and 31b.

Alternatively, for example, the filler 18 may contain at least one selected from the group consisting of Mg, Si, and Mn, and the content of the at least one selected from the group consisting of Mg, Si, and Mn may be higher by 0.01 to 3 mol % than that of the dielectric layers 25. With such a filler 18, crystal grain boundaries included in the filler 18 can improve adhesion between the dielectric layers 25 and the filler 18.

Alternatively, for example, the filler 18 may contain at least one selected from the group consisting of Mg, Si, and Mn and may contain an oxide of a metal identical to a metal contained in the internal electrode layers 30. Such a filler 18 has an effect of oxidizing part of the internal electrode layers 30 in contact with the filler 18, enabling improvement in adhesion between the filler 18 and the internal electrode layers 30.

Note that the multilayer ceramic capacitor 10 may include no filler 18 illustrated in FIGS. 3 and 4. In this situation, between surfaces of the irregularities of the lead-out portion side edges 31a and 31b or the like and the insulating layers 12 and 13 is a pore. Description with reference to FIGS. 3 and 4 has been provided using the example of the first internal electrode layers 30a; however, the second internal electrode layers 30b also have structures similar to those of the first internal electrode layers 30a except that the second internal electrode layers 30b are opposite in the Y-axis direction from the first internal electrode layers 30a. Provided that either the internal electrode layers 30a or 30b included in the multilayer ceramic capacitor 10 have the irregular structure illustrated in FIGS. 3 and 4, reduction of stress concentration and control of adhesion bring the effect of preventing a crack.

In the multilayer ceramic capacitor 10 illustrated in FIGS. 1 to 4, the dielectric layers 25 of the element body 20 may contain any constituent material. The material contains, for example, a dielectric material with a perovskite structure (e.g., ABO₃) or niobium oxide alkaline ceramic as a main component.

In ABO₃, for example, A includes at least one of Ca, Ba, Sr, and the like whereas B includes at least one of Ti, Zr, and the like. The molar ratio of A/B is not limited and is 0.980 to 1.020.

Other than the above, subcomponents may include silicon dioxide, aluminum oxide, alkaline earth metal compounds (e.g., magnesium oxide), manganese oxide, rare earth element oxide, and vanadium oxide but are not limited thereto. Their content is appropriately determined according to the composition or the like.

The internal electrode layers 30 illustrated in FIG. 1 may contain any conductive material. Metals, such as Ni, Cu, Ag, Pd, Al, and Pt, or their alloys can be used. Preferred as a Ni alloy is an alloy of Ni and at least one selected from the group consisting of Mn, Cr, Co, and Al. This alloy has a Ni content of preferably 95 wt % or more. Ni or the Ni alloy may contain approximately 0.1 wt % or less various trace components, such as P.

To form the internal electrode layers 30, a commercially available electrode paste may be used. The thickness of the internal electrode layers 30 is appropriately determined according to a use or the like.

The insulating layers 12 and 13 can contain, for example, a dielectric material with a perovskite structure (e.g., ABO₃) or niobium oxide alkaline ceramic as a main component, similarly to the dielectric layers 25 of the element body 20.

Alternatively, the insulating layers 12 and 13 may contain glass as a main component.

Being composed of a glass component enables the insulating layers 12 and 13 to have high bonding strength. It is assumed that this is because formation of a reaction phase at an interface between the glass and the element body 20 makes adhesion between the glass and the element body 20 superior to adhesion between other insulating materials and the element body 20.

The external electrodes 14 and 16 illustrated in FIG. 1 are composed of a known conductive material (e.g., Cu, Ni, Ag, Pd, Pt, Au, their alloys, and conductive resin). The thickness of the external electrodes 14 and 16 is appropriately determined according to a use or the like.

In FIG. 1, the X-axis, the Y-axis, and the Z-axis are perpendicular to each other, and the Z-axis corresponds to the lamination direction of the dielectric layers 25 and the internal electrode layers 30.

The shape or the size of the element body 20 is appropriately determined according to a purpose or a use. Preferred are a width W0 of 0.1 mm to 1.6 mm in the X-axis direction, a length L0 of 0.2 mm to 3.2 mm in the Y-axis direction, and a height H0 of 0.1 mm to 1.6 mm in the Z-axis direction.

Method of manufacturing multilayer ceramic capacitor 10

A method of manufacturing the multilayer ceramic capacitor 10 as one embodiment of the present invention is specifically described next.

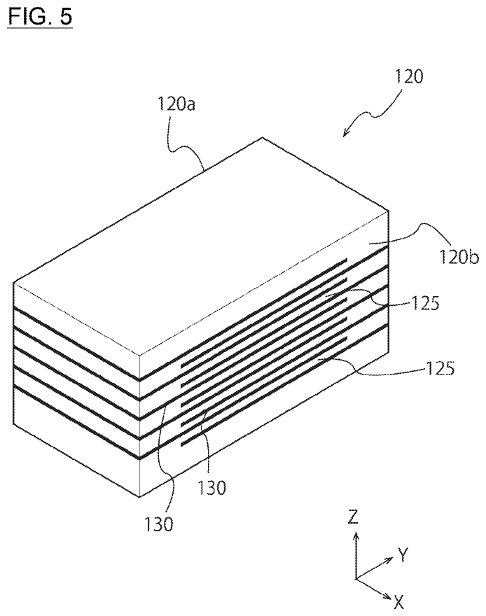

First, a first green chip 120 illustrated in FIG. 5 is prepared. The first green chip 120 illustrated in FIG. 5 is prepared by alternately laminating dielectric green sheets (dielectric green layers 125), which become the dielectric layers 25 after firing, and internal electrode pattern layers 130, which become the internal electrode layers 30 after firing, and then cutting the laminate into pieces.

The dielectric green sheets, which become the dielectric green layers 125 after the cutting into pieces, are prepared using an organic solvent based paste that results from kneading a ceramic powder and an organic vehicle or using a water based paste. The internal electrode pattern layers 130 are prepared using an internal electrode layer paste that results from kneading a conductive material containing a conductive metal or alloy and an organic vehicle.

Note that, as illustrated in FIG. 5, at side surfaces 120a and 120b of the first green chip 120, side edges of the internal electrode pattern layers 130 are exposed. The side edges constitute both ends of the internal electrode pattern layers 130 in the X-axis direction.

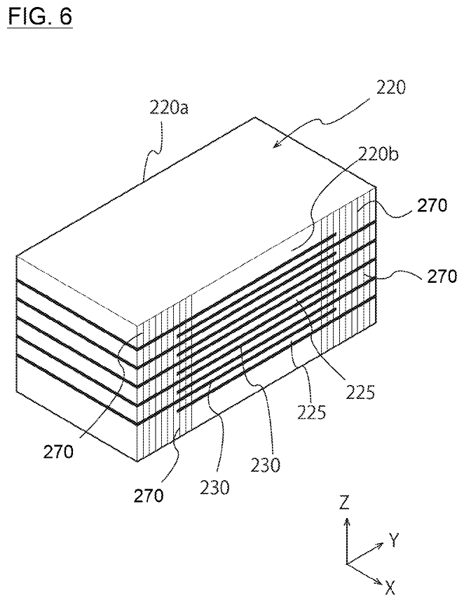

Then, at predetermined locations of the side surfaces 120a and 120b of the first green chip 120 illustrated in FIG. 5, grooves 270 continuing in the Z-axis direction are formed at intervals to provide a second green chip 220 illustrated in FIG. 6.

FIG. 7(A) is a schematic sectional view of the second green chip 220 illustrated in FIG. 6 cut in a section that passes one internal electrode pattern layer 230 and is parallel to an XY plane. FIG. 7(B) is a partial enlarged view of a portion of the internal electrode pattern layer 230 that becomes the lead-out portion side edge 31a after firing and its surroundings (see FIG. 4(A)).

As illustrated in FIG. 7(B), the internal electrode pattern layer 230 of the second green chip 220 has irregularities 232 at the portion that becomes the lead-out portion side edge 31a after firing (see FIG. 4(A)). The internal electrode pattern layer 230 of the second green chip 220 also has irregularities 238 at a portion that becomes the overlapping portion side edge uneven part 35b after firing (see FIG. 4(A)). Moreover, a dielectric green layer 225 of the second green chip 220 has irregularities 272 at portions that become the dielectric layer end side edges after firing (see the dielectric layer end side edges 25aa and 25ab in FIG. 3). Note that portions of the dielectric green layer 225 other than extremities of the irregularities 272 overlap the rear of the internal electrode when viewed from the Z-axis direction and that only the extremities of the irregularities 272 are seen exposed from the irregularities 232.

The shapes of the irregularities 232, 238, and the like illustrated in FIG. 7(B) are substantially the same as those of the irregularities 32, 38, and the like illustrated in FIG. 4(A).

In such a manner, the grooves 270 of side surfaces 220a and 220b of the second green chip 220 constitute the irregularities 232 and 238 of the internal electrode pattern layer 230 and the dielectric green layer 225. The grooves 270 can be formed by, for example, performing a laser processing on the side surfaces 120a and 120b of the first green chip 120; however, methods of forming the grooves 270 are not limited only to the laser processing.

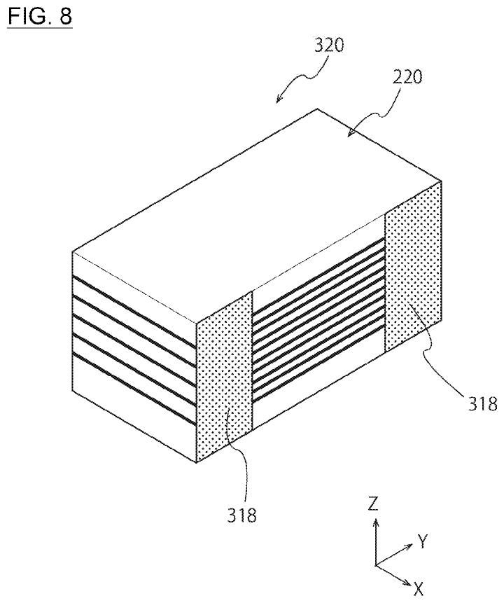

Then, the grooves 270 of the side surfaces 220a and 220b of the second green chip 220 illustrated in FIG. 7 are filled with a filling material 318, which becomes the filler 18 after firing, to provide a third green chip 320 illustrated in FIG. 8. As illustrated in FIG. 8, side surfaces of the third green chip 320 have a layer of the filling material 318.

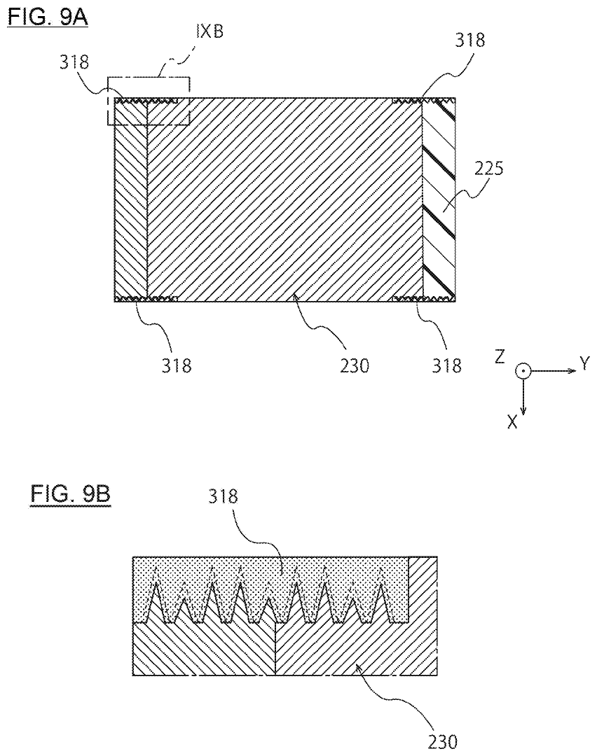

FIG. 9(A) is a schematic sectional view of the third green chip 320 illustrated in FIG. 8 cut in a section that passes one internal electrode pattern layer 230 and is parallel to an XY plane. FIG. 9(B) is a partial enlarged view of the portion of the internal electrode pattern layer 230 that becomes the lead-out portion side edge 31a after firing and its surroundings (see FIG. 4(A)).

As illustrated in FIGS. 9(A) and 9(B), the irregularities 232 and 238 of the internal electrode pattern layer 230 and the dielectric green layer 225 formed in the previous step are filled with the filling material 318. The filling material 318 is provided at the predetermined locations of the side surfaces 220a and 220b of the second green chip 220 through, for example, application, printing, transfer, vapor deposition, or sputtering.

Then, on both side surfaces of the third green chip 320 illustrated in FIG. 8, insulating material layers, which become the insulating layers 12 and 13 after firing, are formed through transfer or the like. Then, this is solidified and fired to provide the element body 20 having the insulating layers 12 and 13 at the side surfaces 20a and 20b as illustrated in FIG. 2.

In a situation where the irregularities 32 and 38 are not filled with the filler 18, the step illustrated in FIGS. 8 and 9 is omitted. That is, in a situation where the irregularities 32 and 38 are not filled with the filler 18, the insulating material layers, which become the insulating layers 12 and 13 after firing, are formed on both side surfaces of the second green chip 220 illustrated in FIG. 6 through transfer or the like, and then this is solidified and fired to provide the element body 20 (see FIG. 2).

Finally, the end surfaces 20c and 20d of the element body 20 are provided with the external electrodes 14 and 16. This provides the multilayer ceramic capacitor 10 illustrated in FIG. 1 and the like. The external electrodes 14 and 16 are formed on the end surfaces 20c and 20d of the element body 20 through, for example, baking of a conductive material, electrolytic plating, or electroless plating.

As described above, the lead-out portion side edges 31a and 31b of the first internal electrode layers 30a and the second internal electrode layers 30b of the multilayer ceramic capacitor 10 illustrated in the embodiment have the irregularities 32, where the internal electrode layers 30a and 30b are partly dug toward a center in the first axis direction (X-axis direction), as illustrated in FIGS. 3 and 4(A). According to such a multilayer ceramic capacitor 10, while adhesion between the lead-out portion side edges 31a and 31b and their surrounding portions is controlled, the proportion of the internal electrode layers 30a and 30b with thermal shrinkage behavior different from that of the dielectric layers 25 or the insulating layers 12 and 13 at corners of the element body 20 or in the vicinity of boundaries between the internal electrode lead-out portions 31 and the internal electrode overlapping portion 34 can be reduced. This can prevent stress concentration at vulnerable portions due to a difference in thermal shrinkage behavior between the internal electrode layers 30a and 30b and the dielectric layers 25 and the insulating layers 12 and 13 and can appropriately control adhesion between layers near the lead-out portion side edges 31a and 31b. Thus, the element body 20 can be suitably prevented from having a crack.

### EXAMPLES

Hereinafter, the present disclosure is described based on further detailed examples. However, the present disclosure is not construed as limited to these examples.

### Example 1

Using the method of manufacturing a multilayer ceramic capacitor 10 described in the description of the embodiment, one thousand multilayer ceramic capacitor samples according to Example 1 were manufactured under the following conditions. Using these samples, the presence or absence of a crack, capacitance, and whether a short circuit occurred were evaluated. The crack occurrence rate, capacitance (percentage with respect to a standard value), and short circuit rate of Example 1 were evaluated.
Conditions of Example 1 were as follows.
Chip size: 0603 chip
Capacitance (standard value): 1 μF
Average depth of lead-out portion side edge depressions 33: 0.2 μm
Average depth of central part side edge depressions 37: 0 μm
Surface roughness Ra of lead-out portion side edges 31a and 31b: 80 nm
Surface roughness Ra of overlapping portion side edge central part 35a: 50 nm
Percentage of lead-out portion side edge+uneven part (L2/L1): 20%
Percentage of central part (L3/L1): 80%
Filler 18: None

That the average depth of the lead-out portion side edge depressions 33, the average depth of the central part side edge depressions 37, the surface roughness Ra of the lead-out portion side edges 31a and 31b, and the surface roughness Ra of the overlapping portion side edge central part 35a were as intended was confirmed by exposing each portion through polishing or the like and observing it with a laser microscope (VK-X1000 manufactured by KEYENCE CORPORATION). Table 1 shows sample conditions and evaluation results of Example 1, as well as other Examples and Comparative Examples.

TABLE 1

| | Sample conditions | | | | | | | | | |
|---|---|---|---|---|---|---|---|---|---|---|
| | | | | Surface | (Lead-out | | | | | |
| | Average | | Surface | roughness | portion side | Central | | | | |
| | depth of | Average | roughness | Ra of | edge + | part/ | | Evaluation results | | |
| | lead-out | depth of | Ra of | overlapping | uneven part)/ | internal | | | | Short |
| | portion | central part | lead-out | portion | internal | electrode | | Crack | | circuit |
| | side edge | side edge | portion | side edge | electrode layer | layer | | occurrence | Capac- | rate |
| | depressions | depressions | side edge | central part | L2/L1 | L3/L1 | Filer | (%) | itance | (IR) |
| Example 1 | 0.2 μm | 0 μm | [symbol] | 50 nm | 20% | 80% | N/A | 4% | 100% | 0% |
| Example 2 | 10 μm | 0 μm | 1300 nm | 50 nm | 20% | 80% | ↑ | 2% | 98% | 0% |
| Example 3 | 0.1 μm | 0 μm | 60 nm | 50 nm | 20% | 80% | ↑ | 7% | 100% | 0% |
| Example 4 | 12 μm | 0 μm | 1300 nm | 50 nm | 20% | 80% | ↑ | 7% | 96% | 0% |
| Example 5 | 5 μm | 2 μm | 800 nm | 200 nm | 20% | 80% | ↑ | 0% | 98% | 0% |
| Example 6 | 5 μm | 3 μm | 800 nm | 300 nm | 20% | 80% | ↑ | 0% | 95% | 0% |
| Example 7 | 0.2 μm | 0 μm | [symbol] | 50 nm | 20% | 80% | ↑ | [symbol] | 100% | 0% |
| Example 8 | 10 μm | 0 μm | 1600 nm | 50 nm | 20% | 80% | ↑ | 7% | [symbol] | 0% |
| Example 9 | 5 μm | 2 μm | 800 nm | 350 nm | 20% | 80% | ↑ | 4% | [symbol] | 0% |
| Example 10 | 0.2 μm | 0 μm | 20 nm | 50 nm | 10% | 90% | ↑ | 4% | 100% | 2% |
| Example 11 | 0.2 μm | 0 μm | [symbol] | [symbol] | 40% | 60% | ↑ | 1% | 99% | 0% |
| Example 12 | 0.2 μm | 0 μm | [symbol] | 50 nm | 8% | [symbol] | ↑ | 8% | 100% | [symbol] |
| Example 13 | 0.2 μm | 0 μm | [symbol] | 50 nm | 70% | 30% | ↑ | 2% | 96% | 0% |
| Example 14 | 0.2 μm | 0 μm | [symbol] | 50 nm | 20% | 80% | Filled with | 0% | 100% | 0% |
| | | | | | | | same composition | | | |
| Example 15 | 0.2 μm | 0 μm | [symbol] | 50 nm | 20% | 80% | 0.01 mol Mg added | 0% | 100% | 0% |
| Example 16 | 0.2 μm | 0 μm | [symbol] | 50 nm | 20% | 80% | 0.3 mol Mg added | 0% | 98% | 0% |
| Example 17 | 0.2 μm | 0 μm | [symbol] | 50 nm | 20% | 80% | 0.5 mol Mg added | 0% | 95% | 0% |
| Example 18 | 0.2 μm | 0 μm | [symbol] | 50 nm | 20% | 80% | 0.3 mol Mg added | 0% | 98% | 0% |
| | | | | | | | N-Mg ozide formed | | | |
| Comparative | 0 μm | 0 μm | 50 nm | 50 nm | Incalculable | Incalcu- | N/A | 18% | Lot | Lot |
| Example 1 | | | | | | lable | | | rejection | rejection |
| Comparative | 0 μm | 5 μm | 50 nm | 100 nm | Incalculable | Incalcu- | N/A | 18% | Lot | Lot |
| Example 2 | | | | | | lable | | | rejection | rejection |

[symbol]

indicates data missing or illegible when filed

### Examples 2 to 4

Manufacture of samples and their evaluation were conducted as in Example 1 except that, among the sample conditions, the average depth of the lead-out portion side edge depressions 33 was changed to 10 μm, 0.1 μm, or 12 μm and the surface roughness Ra of the lead-out portion side edges 31a and 31b was changed to 1300 nm, 60 nm, or 1300 nm.

### Examples 5 and 6

Manufacture of samples and their evaluation were conducted as in Example 1 except that, among the sample conditions, the average depth of the lead-out portion side edge depressions 33 was changed to 5 μm, the surface roughness Ra of the lead-out portion side edges 31a and 31b was changed to 800 nm, the average depth of the central part side edge depressions 37 was changed to 2 μm or 3 μm, and the surface roughness Ra of the overlapping portion side edge central part 35a was changed to 200 nm or 300 nm.

### Example 7

Manufacture of samples and their evaluation were conducted as in Example 1 except that, among the sample conditions, the surface roughness Ra of the lead-out portion side edges 31a and 31b was changed to 53 nm.

### Example 8

Manufacture of samples and their evaluation were conducted as in Example 2 except that, among the sample conditions, the surface roughness Ra of the lead-out portion side edges 31a and 31b was changed to 1600 nm.

### Example 9

Manufacture of samples and their evaluation were conducted as in Example 5 except that, among the sample conditions, the surface roughness Ra of the overlapping portion side edge central part 35a was changed to 350 nm.

### Examples 10 to 13

Manufacture of samples and their evaluation were conducted as in Example 1 except that, among the sample conditions, L2/L1 (see FIG. 3) was changed to 10%, 40%, 8%, or 70% and L3/L1 (see FIG. 3) was changed to 90%, 60%, 92%, or 30%.

### Example 14

Manufacture of samples and their evaluation were conducted as in Example 1 except that, among the sample conditions, irregularities of the lead-out portion side edges 31a and 31b and the uneven part 35b were filled with a filler 18 with a composition same as that of insulating layers 12 and 13.

### Examples 15 to 17

Manufacture of samples and their evaluation were conducted as in Example 14 except that, among the sample conditions, the filler 18 had 0.01 mol, 0.3 mol, or 0.5 mol Mg added to the same composition of the insulating layers 12 and 13.

### Example 18

Manufacture of samples and their evaluation were conducted as in Example 14 except that, among the sample conditions, the filler 18 had 0.3 mol Mg added to the same composition of the insulating layers 12 and 13 and contained a Ni—Mg oxide.

### Comparative Example 1

Manufacture of samples and their evaluation were conducted as in Example 1 except that, among the sample conditions, both the average depth of the lead-out portion side edge depressions 33 and the average depth of the central part side edge depressions 37 were changed to 0 μm and both the surface roughness Ra of the lead-out portion side edges 31a and 31b and the surface roughness Ra of the overlapping portion side edge central part 35a were changed to 50 nm. Note that, in Comparative Example 1, because the irregularities of the lead-out portion side edges 31a and 31b were not larger than the irregularities of the overlapping portion side edge central part 35a, L2/L1 and L3/L1 were incalculable.

### Comparative Example 2

Manufacture of samples and their evaluation were conducted as in Example 1 except that, among the sample conditions, the average depth of the lead-out portion side edge depressions 33 was changed to 0 μm, the surface roughness Ra of the lead-out portion side edges 31a and 31b was changed to 50 nm, the average depth of the central part side edge depressions 37 was changed to 5 μm, and the surface roughness Ra of the overlapping portion side edge central part 35a was changed to 100 nm. Note that, in Comparative Example 2, because the irregularities of the lead-out portion side edges 31a and 31b were not larger than the irregularities of the overlapping portion side edge central part 35a, L2/L1 and L3/L1 were incalculable.

In Examples 1 to 18, all samples had a crack occurrence rate of 10% or less, a capacitance of 95% or more, and a short circuit rate of 10% or less, providing good evaluation results. In particular, in Examples 1 to 18, a significant reduction in the crack occurrence rate was confirmed, in comparison with Comparative Examples 1 and 2. Note that, Comparative Examples 1 and 2 were determined as rejected lots because the crack occurrence rate exceeded 10%. Thus, their evaluation of capacitance and short circuit rate was omitted.

### REFERENCE NUMERALS

10 . . . multilayer ceramic capacitor
20 . . . element body
20a, 20b, 120a, 120b, 220a, 220b . . . side surface
20c, 20d . . . end surface
30 . . . internal electrode layer
30a . . . first internal electrode layer
30b . . . second internal electrode layer
31 . . . internal electrode lead-out portion
31a . . . lead-out portion side edge
31b . . . lead-out portion side edge (other side)
32, 36, 38, 272, 232, 238 . . . irregularities
D . . . depth
32DA, 36DA, 38DA . . . average depth
33 . . . lead-out portion side edge depression
33D . . . depth of lead-out portion side edge depression
33DA . . . average depth of lead-out portion side edge depressions
34 . . . internal electrode overlapping portion
35 . . . overlapping portion side edge
35a . . . overlapping portion side edge central part
37 . . . central part side edge depression
35b . . . overlapping portion side edge uneven part
39 . . . uneven part side edge depression
39D . . . depth of uneven part side edge depression
39DA . . . average depth of uneven part side edge depressions
25 . . . dielectric layer
25a . . . dielectric layer end
25aa, 25ab . . . dielectric layer end side edge
12, 13 . . . insulating layer
14, 16 . . . external electrode
18 . . . filler
120 . . . first green chip
125, 225 . . . dielectric green layer
130, 230 . . . internal electrode pattern layer
220 . . . second green chip
270 . . . groove
320 . . . third green chip
318 . . . filling material

What is claimed is:

1. A multilayer electronic device comprising:
an element body comprising internal electrode layers and dielectric layers, the internal electrode layers and the dielectric layers being alternately laminated along a direction of a third axis and being substantially parallel to a plane containing a first axis and a second axis,
wherein
the element body comprises side surfaces in pairs each being provided with an insulating layer, the side surfaces facing each other in a direction of the first axis;
the element body comprises end surfaces in pairs each being provided with an external electrode electrically connected to the internal electrode layers, the end surfaces facing each other in a direction of the second axis;
the internal electrode layers comprise first internal electrode layers and second internal electrode layers;
the first internal electrode layers connect to the external electrode on one of the end surfaces in pairs;
the second internal electrode layers connect to the external electrode on an other one of the end surfaces in pairs;
the internal electrode layers comprise an internal electrode overlapping portion and an internal electrode lead-out portion;
the internal electrode overlapping portion is where the first internal electrode layers and the second internal electrode layers overlap when viewed from the direction of the third axis;
the internal electrode lead-out portion is where the first internal electrode layers and the second internal electrode layers do not overlap when viewed from the direction of the third axis;
the internal electrode lead-out portion comprises a lead-out portion side edge at either end in the direction of the first axis;
the internal electrode overlapping portion comprises an overlapping portion side edge at either end in the direction of the first axis;
the overlapping portion side edge comprises an overlapping portion side edge central part at a center in the direction of the second axis; and
at least one of the internal electrode layers has larger irregularities along the direction of the second axis at the lead-out portion side edge than at the overlapping portion side edge central part.

2. The multilayer electronic device according to claim 1, wherein, in the at least one of the internal electrode layers,
a length along the direction of the first axis between the insulating layer and the lead-out portion side edge or the overlapping portion side edge is defined as a depth of the lead-out portion side edge or the overlapping portion side edge;
the lead-out portion side edge has lead-out portion side edge depressions each having a largest depth between two second-axially adjacent points at an average depth of the lead-out portion side edge;
the lead-out portion side edge depressions have an average depth of 0.2 to 10 μm;
the overlapping portion side edge central part has central part side edge depressions each having a largest depth between two second-axially adjacent points at an average depth of the overlapping portion side edge central part;
the central part side edge depressions have an average depth of 0 to 2 μm; and
the average depth of the lead-out portion side edge depressions is larger than the average depth of the central part side edge depressions.

3. The multilayer electronic device according to claim 1, wherein
a length along the direction of the first axis between the insulating layer and the lead-out portion side edge or the overlapping portion side edge is defined as a depth of the lead-out portion side edge or the overlapping portion side edge;
the lead-out portion side edge has lead-out portion side edge depressions each having a largest depth between two second-axially adjacent points at an average depth of the lead-out portion side edge; and
the at least one of the internal electrode layers has a (A−B1−B2)/A of 0.9 or more, where
“A” denotes a maximum width of the internal electrode lead-out portion along the direction of the first axis,
“B1” denotes an average depth of the lead-out portion side edge depressions of the lead-out portion side edge at one side in the direction of the first axis, and
“B2” denotes an average depth of the lead-out portion side edge depressions of the lead-out portion side edge at an other side in the direction of the first axis.

4. The multilayer electronic device according to claim 3, wherein both B1 and B2 are 0.2 to 10 μm.

5. The multilayer electronic device according to claim 1, wherein
a length along the direction of the first axis between the insulating layer and the lead-out portion side edge or the overlapping portion side edge is defined as a depth of the lead-out portion side edge or the overlapping portion side edge;
in the at least one of the internal electrode layers,
the overlapping portion side edge central part has a maximum depth not exceeding 50% of that of the lead-out portion side edge;
the overlapping portion side edge comprises an overlapping portion side edge uneven part having a maximum depth exceeding 50% of that of the lead-out portion side edge;
the overlapping portion side edge comprises the overlapping portion side edge central part and the overlapping portion side edge uneven part; and
the overlapping portion side edge uneven part comprises overlapping portion side edge uneven parts in pairs disposed at both sides of the overlapping portion side edge central part in the direction of the second axis.

6. The multilayer electronic device according to claim 5, wherein
a length of the overlapping portion side edge central part along the direction of the second axis is 40% to 90% of an entire length of the at least one of the internal electrode layers along the direction of the second axis; and
a sum of lengths of the overlapping portion side edge uneven part and the lead-out portion side edge along the direction of the second axis is 10% to 60% of the entire length of the at least one of the internal electrode layers along the direction of the second axis.

7. The multilayer electronic device according to claim 5, wherein a sum of lengths of the overlapping portion side edge uneven part and the lead-out portion side edge of the at least one of the internal electrode layers along the direction of the second axis is 40 to 100 μm.

8. The multilayer electronic device according to claim 1, wherein
the lead-out portion side edge has a surface roughness Ra of 100 to 1000 nm along the direction of the second axis; and
the overlapping portion side edge central part has a surface roughness Ra being smaller than that of the lead-out portion side edge and being 10 to 200 nm along the direction of the second axis.

9. The multilayer electronic device according to claim 1, comprising a filler at least partly filling the irregularities of the lead-out portion side edge between the side surfaces of the element body and the insulating layer.

10. The multilayer electronic device according to claim 9, wherein 90% or more of a composition of the filler in mole percent matches a composition of the insulating layer or the dielectric layers.

11. The multilayer electronic device according to claim 9, wherein 20% or more of a composition of the filler in mole percent differs from a composition of the insulating layer or the dielectric layers.

12. The multilayer electronic device according to claim 9, wherein
the filler comprises at least one selected from the group consisting of Mg, Si, and Mn; and
a content of the at least one selected from the group consisting of Mg, Si, and Mn is higher by 0.01 to 3 mol % than that of the dielectric layers.

13. The multilayer electronic device according to claim 9, wherein
the filler comprises at least one selected from the group consisting of Mg, Si, and Mn; and
the filler comprises an oxide of a metal identical to a metal contained in the internal electrode layers.
